(19) United States
(12) Patent Application Publication
(10) Pub. No.: US 2011/0209791 A1
(43) Pub. Date: Sep. 1, 2011

(54) Multilayer Flexible Irrigating Hose

(75) Inventor: Alessandro Mezzalira, Sandrigo (VI) (IT)

(73) Assignee: FITT S.P.A., Sandrigo (VI) (IT)

(21) Appl. No.: 13/125,561

(22) PCT Filed: Nov. 4, 2009
(86) PCT No.: PCT/IB2009/054903

§ 371 Date: Apr. 26, 2011

(30) Foreign Application Priority Data
Nov. 4, 2008 (IT) VI2008A000260

(51) Int. Cl. F16L 11/08; D04B 9/00; D04B 1/22; B29C 47/02

(52) U.S. Cl. 138/126; 66/9 R; 66/190; 156/393

(57) ABSTRACT

A multilayer flexible irrigation hose includes an inner layer made of a first thermoplastic polymer material, an outer layer made of a second thermoplastic polymer material, and a first textile reinforcement layer and a second textile reinforcement layer in mutually overlapping relation. The first and second textile reinforcement layers are knitted with stitches of the tricot type, having wales of stitches and lines of stitches. The lines of stitches of said first and second textile layers have opposite inclinations to the longitudinal axis of the hose, and the wales of stitches of at least one of said first and second textile layers are substantially parallel to said longitudinal axis. A method of making said hose, a line for manufacturing same and a knitting apparatus for making such hose are also disclosed.

### FIELD OF INVENTION

The present invention generally finds application in the art of flexible hoses, and particularly relates to an irrigation hose having a double knitted layer.

The invention also relates to a method of making such hose, a line for manufacturing the same and a knitting apparatus for making such hose.

### BACKGROUND ART

Flexible hoses having a single textile layer are known in the art, and comprise an inner layer susceptible of contacting the liquid to be carried, an outer layer susceptible of being held by a user, and a textile tricot layer therebetween. One example of such hose is known from European Patent EP-B1-0623776.

In such prior art hose, the wales of stitches and the lines of stitches of the textile layer have opposite inclinations to the axis of the hose.

Such hose has good anti-kink properties and a relatively high burst pressure. It can be also manufactured in a simple and quick manner.

Flexible hoses having a double textile knitted layer are also known in the art, and comprise an inner layer susceptible of contacting the liquid to be carried, an outer layer susceptible of being held by a user, and a pair of textile layers with stitches of tricot type in mutual overlapping relation, interposed between the inner and outer layers. An example of such prior art hose is known from EP-B1-1156252.

In such prior art hose, the wales of stitches and the lines of stitches of both textile layers have opposite inclinations to the axis of the hose.

While this prior art hose has good anti-kink properties and a higher burst pressure than the hose with a single textile layer, it still has the drawbacks of difficult manufacture and relatively poor throughput.

Therefore, the need has long been felt for a flexible irrigation hose having a double textile knitted layer with stitches of tricot type that can be manufactured in a simple, inexpensive and quick manner.

### DISCLOSURE OF THE INVENTION

The object of the present invention is to at least partially obviate the above drawbacks, by providing a hose with a double textile knitted layer that can be manufactured in a much simpler and quicker manner than homologous prior art hoses, while maintaining optimal anti-kink and burst pressure performances.

These and other objects, as better explained hereafter, are fulfilled by a knitting apparatus according to the invention.

With this configuration, the hose can be manufactured in a highly simple, inexpensive and quick manner, while maintaining good anti-kink and burst pressure properties.

In practice, as experimentally shown below, the hose of the invention has anti-kink and burst pressure properties similar to those of prior art hoses with a double knitted layer, with throughputs similar to those of prior art hoses with a single knitted layer.

As used herein, the term “fabric layer” and the like will be intended to indicate a layer composed of at least two yarns or sets of yarns arranged over a substrate.

As used herein, the term “textile knitted layer with stitches of tricot type” and the like will be intended to indicate a layer composed of at least two yarns or sets of yarns arranged over the substrate and interwoven to form a plurality of tricot stitches.

As used herein, the term “stitches of tricot type” and the like is intended to indicate the portion of a yarn (or multiple filament yarns combined into one yarn), that is woven with adjacent yarns to form a generally annular loop. In the enlarged views of FIGS. 2a and 3a, certain “stitches of tricot type” have been differentiated by hatching.

The “stitches of tricot type” are also known in the art as chain stitches.

As used herein, the term “wale of stitches” and the like of a textile knitted layer with stitches of the tricot type is intended to indicate the line defined by the mutually chained “stitches of the tricot type”.

As used herein, the term “lines of stitches” and the like of a textile knitted layer with stitches of the tricot type is intended to indicate the portion of a yarn (or multiple filament yarns combined into one yarn) that connects together two successive “stitches of tricot type” along the same yarn. In the enlarged views of FIGS. 2a and 3a, certain “lines of stitches” have been differentiated by solid lines.

The wales of stitches of both textile knitted layers may be substantially parallel to the axis, to optimize simplicity, throughput and cost effectiveness of hose fabrication.

Advantageously, the first and second polymer materials may be of plasticized or elastomeric type.

The first and second polymer materials may be different or identical. Advantageously, the first and second polymer materials may be mutually compatible.

As used herein, the term “compatible materials” or derivatives thereof shall be intended to indicate materials having a chemical and/or physical compatibility with each other, i.e. materials that, while in joined relationship to form a substantially integral unit, provide a junction adapted to support the transfer of tensile or shear stresses through the contact surface. The highest compatibility is thus achieved between identical materials or having the same matrix base.

As used herein, the term “matrix” of a polymer or derivatives thereof, shall be intended to indicate a polymer material that can provide the molecular structure of the final product.

Conveniently, the first and second polymer materials may all have a plasticized PVC (polyvinyl chloride) based matrix.

As used herein, the term “-based matrix” or derivatives thereof, preceded by the name of a polymer material, shall be intended to indicate a polymer material capable of providing the molecular structure of the polymer material whose name precedes the term “-based matrix” to the final product.

Conveniently, the needles of both series of needles may be rotationally locked, for the wales of stitches of both textile layers to be substantially parallel to the axis.

Advantageously, the needles of both series of needles may face towards each other to optimize simplicity, throughput and cost effectiveness of hose fabrication.

In a further aspect, the invention relates to a method of making the hose as defined hereinafter.

In another aspect, the invention relates to a flexible hose as defined hereinafter.

In a further aspect, the invention relates to a hose manufacturing line as defined hereinafter.

Advantageous embodiments of the invention are defined in accordance with the dependent claims.

### BRIEF DESCRIPTION OF THE DRAWINGS

Further features and advantages of the invention will become more apparent from the detailed description of a few preferred, non exclusive embodiments of a hose of the invention, which are described as non limiting examples with the help with the accompanying drawings in which:

FIG. 1 is a cross sectional view of a hose according to the invention;

FIG. 2 is a schematic view of a first embodiment of a hose according to the invention with the cover 3 partially removed, certain details thereof being enlarged in FIG. 2a;

FIG. 3 is a schematic view of a second embodiment of a hose according to the invention with the cover 3 partially removed, certain details thereof being enlarged in FIG. 3a;

FIG. 4 is a schematic view of a hose manufacturing line according to the invention;

FIG. 5 is a schematic view of a first embodiment of the knitting apparatus for making a hose according to the invention;

FIG. 6 is a schematic view of a second embodiment of the knitting apparatus for making a hose according to the invention;

FIG. 7 is a schematic enlarged view of a knitting section of the apparatus of FIG. 5;

FIG. 8 is a schematic view of a further embodiment of the hose of the invention with the cover 3 partially removed.

### DETAILED DESCRIPTION OF A PREFERRED EMBODIMENT

Referring to the above figures, a flexible hose according to the invention, generally designated by numeral 1, may be particularly designed for use as a domestic irrigation hose, e.g. in a garden.

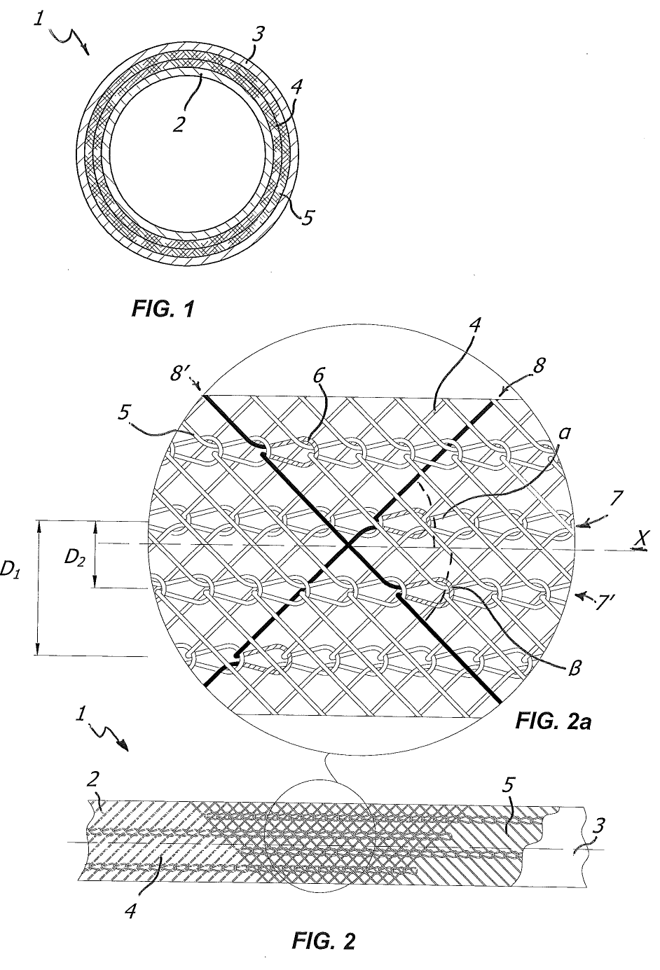

Essentially, as shown in FIG. 1, the hose 1 is composed of an inner tubular layer or substrate 2, made of plasticized PVC, which is designed to contact the liquid to be carried, an outer polymer layer or cover 3, also made of plasticized PVC, which is designed to be held by a user, and a first and a second textile layers 4, 5 in overlapping relation, possibly formed of a polyester yarn, interposed therebetween.

Additional layers, of either textile or polymeric nature, may be also provided between the above layers, without departure from the inventive scope as defined in the annexed claims.

The textile layers 4, 5 are of knitted type with tricot stitches 6, both having wales of stitches, designated by numeral 7 in the first textile layer 4 and by numeral 7′ in the second textile layer 5, and lines of stitches, designated by numerals 8, 8′ respectively. Particularly, the lines of stitches 8, 8′ have opposite inclinations α,β to the axis X of the hose, preferably forming equal angles, whereas the lines of stitches 7 are substantially parallel to such axis.

As particularly shown in FIG. 2, which represents a first embodiment of a hose according to the invention, the lines of stitches 7 of the first textile layer 4 have a circumferential pitch or predetermined distance D₁, whereas the wales of stitches 7′ of the second textile layer 5 have a distance D₂ from the wales of stitches 7 of the first layer 4 that is substantially half the distance D₁. This feature allows the wales of stitches 7, 7′ to be evenly spaced along the periphery of the substrate 2, thereby considerably increasing the burst pressure of the hose 1.

In an alternative embodiment, the wales of stitches 7, 7′ may also be in side-by-side relation.

The hose 1 may be fabricated by the manufacturing line as shown in FIG. 4.

At first, the substrate 2 designed to act as a supporting layer is extruded in a manner known per se, by introducing plasticized PVC into a first extruder 11.

Then, the supporting layer will be introduced into a knitting station 12, adapted to form the first and second textile layers 4, 5 on the substrate 2.

Finally, the semifinished product 13 so obtained will be introduced into a second extruder 14, by loading it from the top with plasticized PVC, so that the cover 3 may be extruded, in a manner known per se, on the upper surface of the semifinished product 13, thereby obtaining the finished hose 1.

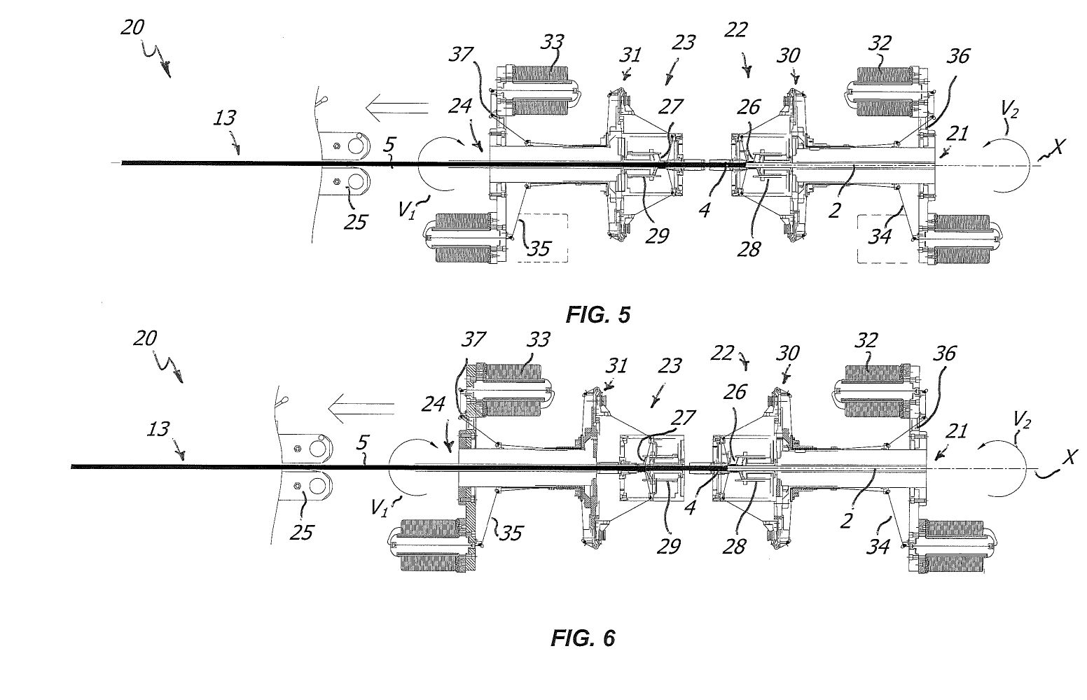

For the purpose of forming the textile layers 4, 5, the knitting station 12 may include the knitting apparatus 20, as schematically shown in FIGS. 5 and 6.

The apparatus 20 substantially comprises an inlet 21 for the supporting substrate 2 that comes from the first extruder 11, a first and a second knitting stations 22, 23 placed in series and an outlet 24 for the semifinished product 13, to be processed by the second extruder 14.

The broken line of FIGS. 5 and 6 is the line along which the supporting layer 2 is fed through the apparatus 20 and further defines a longitudinal axis that coincides with the axis X of the hose. Means 25 may be provided outside the apparatus 20 for pulling the hose along the line of feed X.

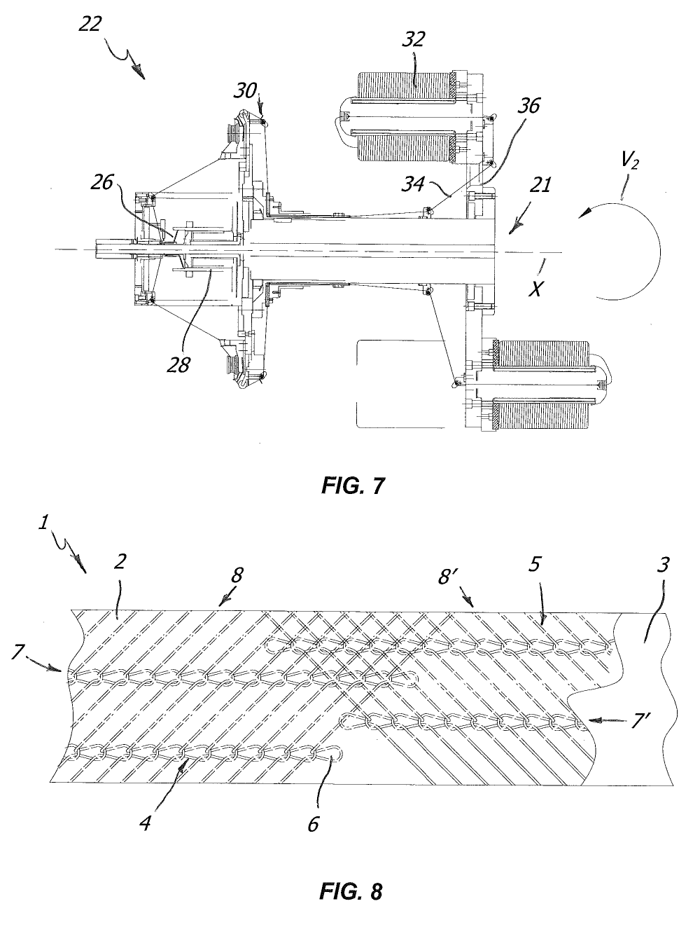

As shown in FIG. 7, representing for simplicity the section 22 only, each of the knitting sections 22, 23 will have a series of needles 26, 27, fixed to a corresponding needle-holding cage 28, 29, which are operably connected by tensioning and return means, generally designated by numerals 30, 31, to corresponding series of reels 32, 33 of yarn 34, 35, mounted to reel-supporting plates 36, 37.

Any number of reels and needles may be provided. The two sections 22, 23 may have equal numbers of needles and corresponding reels, such as eight for each series. In a preferred, non limiting embodiment, there may be a needle for each reel, and the number of needles may correspond to the number of wales of stitches 7, 7′ that will be formed on the substrate 2.

In operation, the needles 26, 27 will pick up the yarn 34, 35 from the corresponding reel 32, 33, to weave it with the adjacent yarns and form tricot stitches. The needles 26, 27 and the reels 32, 33 are mounted to needle supports 28, 29 and reel supports 36, 36 respectively, peripherally about the axis X, so that as the substrate 2 is moved forward, first the textile layer 4 and then the textile layer 5 can be formed on its outer surface in overlapped relation.

The reel supporting plates 36, 36 are mounted to the apparatus 20 in such a manner as to rotate about the axis X and are connected by cam means to the needles 26, 27, so that the rotation of the reel supporting plates 36, 37 and the reels 32, 33 connected thereto, causes the reciprocating motion of the needles 26, 27 in the direction defined by the axis X.

In the embodiment as shown in FIG. 5, the needles 26, 27 fixed to the needle-holding cages 28, 29 face towards each other and operate in opposed relation, whereas in the embodiment of FIG. 6, the needles 26, 27 are disposed and operate in the same direction.

In other words, in the apparatus according to the first embodiment, the reciprocating motion of the needles of the first series 26 and those of the second series 27 have opposite directions, so that the forward motion of a needle of the first series 26 causes the facing needle in the second series 27 to move towards the same central reference plane.

Conversely, in the apparatus according to the second embodiment of FIG. 6, such movements have the same directions, so that the forward motion of a needle of the first series 26 towards a central reference plane causes the needle aligned therewith in the second series 27 to move away from the same central reference plane.

In both embodiments, the cam means will be appropriately sized and/or configured to obtain the above described effect.

As a result, with the apparatus of the first embodiment, the stitches of both textile layers will be knit stitches, whereas in the second embodiment, the stitches of the underlying layer will be knit stitches, as shown in FIG. 2, whereas the second stitches will be purl stitches, as shown in FIG. 8.

The apparatus 20 includes motor means, not shown and known per se, which are adapted to rotate the reel-supporting plates 36, 37 in opposite directions, e.g. one clockwise V₁ and the other counterclockwise V₂.

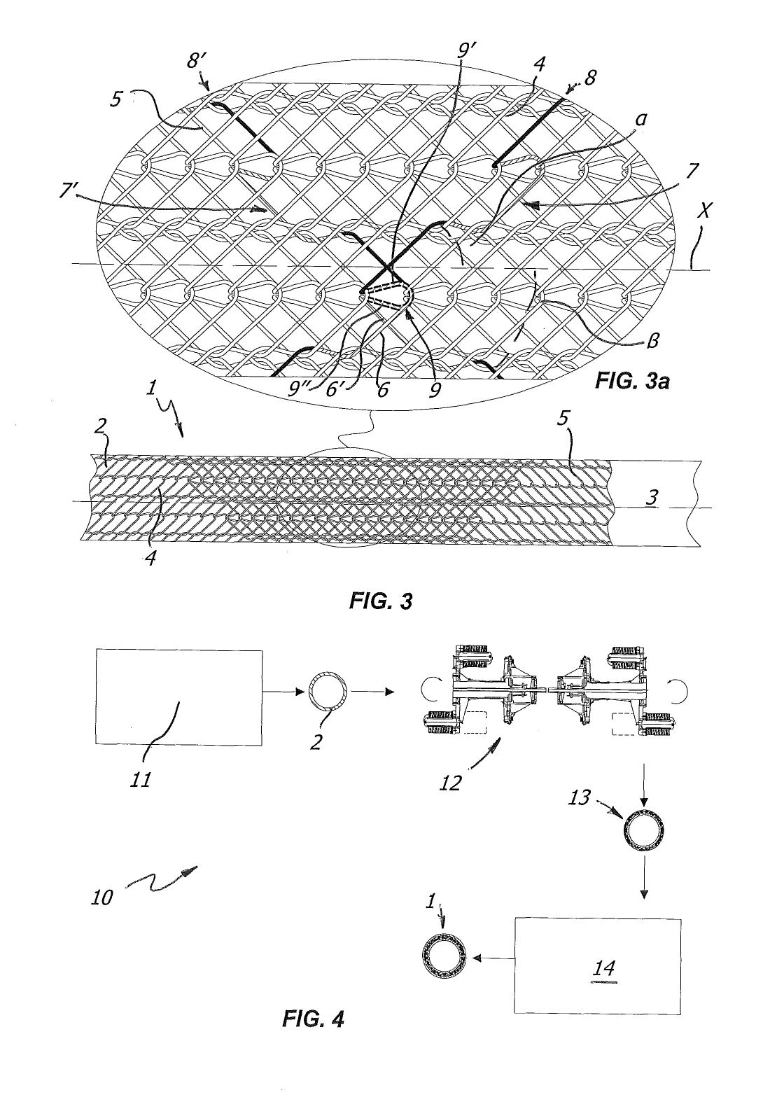

Thus, the first knitting section 22 will form the first textile layer 4 with lines of stitches 8 inclined in one direction to the axis X, whereas the second knitting section 23 will form, on the first layer 4, the second textile layer 5, lines of stitches 8′ inclined in an opposite direction, as shown in FIGS. 2 and 3.

The inclination of the lines of stitches 8, 8′ will be controlled by the speed at which the motor means, which may be independent of each other, will rotate the reel-supporting plates 36, 37. In a preferred embodiment, the two plates may have equal rotating speeds, to obtain equal inclinations of the lines of stitches 8, 8′.

The needle-holding cages 28, 29 will be mounted to the machine 20, to hold the needles 26, 27 in rotationally locked positions. In other words, the needles 26, 27 will be free to translate along the axis X, alternately in both directions to create the stitches 6, but cannot rotate about it.

Thus, the lines of stitches 7, 7′ of the textile layers 4, 5 will be substantially parallel to the axis X.

The following table briefly describes some comparative tests carried out on a hose specimen of the invention (“Spec. 1”), on a specimen formed as taught in European Patent EP-B1-0623776 (“Spec. 2”) and on a specimen formed as taught by the European Patent EP-B1-1156252 (“Spec. 3”).

The first column shows the torsion angle value obtained by blowing air at a pressure of 3 bar into a one meter-long hose specimen, held in vertical position by supports that allow it to rotate about its own axis. The angle of rotation (degrees) of the hose was measured using a goniometer attached to the base of the hose. The three hose specimens under test had the same interior diameter, 15.88 mm (⅝ inches, ⅝″).

The second column shows the burst pressure value obtained according to the standard UNI EN ISO 1402:1997 (Rubber and plastic hoses and hose assemblies. Hydrostatic tests).

The third column shows experimentally measured line speed values.

| | | | Line speed, |
|---|---|---|---|
| | Tors. angle, ° | Burst pressure, bar | mₕₒₛₑ/min |
| Spec. 1 | 11 | 36 | 7 |
| Spec. 2 | 12 | 26 | 7 |
| Spec. 3 | 10 | 38 | 6 |

The above results clearly shows that the hose of the invention fulfils the intended objects, and particularly the object of having anti-kink and burst pressure properties similar to those of prior art hoses with a double knitted layer, with throughputs similar to those of prior art hoses with a single knitted layer.

By increasing the line speed by 1 meter of hose per minute with respect to the prior art, a throughput increase of 480 meters of hose per eight-hour continuous work shift will be obtained.

The method as described above may be also used to form the hose as shown in FIG. 3. In this embodiment, the textile layers 4, 5 have larger stitches 6 as compared with the embodiment of FIG. 2. Also in this embodiment, the lines of stitches 8, 8′ have opposite inclinations α,β to the axis X of the hose, preferably forming equal angles, whereas the lines of stitches 7, 7′ are substantially parallel to such axis.

In this embodiment, as particularly shown in the enlarged view of FIG. 3a, the stitches 6 of the overlapping textile layers 4, 5 are coupled together, at the interweaving points, to form “false loops”, similar to the stitches of the first embodiment. Such “false loops” are formed of transverse portions of two stitches 6 of different overlapping layers.

In the enlarged view of FIG. 3a, for instance, numeral 9 designates a “false loop”, also differentiated by broken lines, which is formed of the transverse portion 9′ of the stitch 6 of the first textile layer 4 and the transverse portion 9″ of the stitch 6′ of the second textile layer 5, which are in side by side relation. The “false loops” will form together “wales” of “false loops” parallel to the axis X of the hose.

The hose of this invention is susceptible of a number of changes and variants, within the inventive concept disclosed in the appended claims. All the details thereof may be replaced by other technically equivalent parts, and the materials may vary depending on different needs, without departure from the scope of the invention.

While the hose has been described with particular reference to the accompanying figures, the numerals referred to in the disclosure and claims are only used for the sake of a better intelligibility of the invention and shall not be intended to limit the claimed scope in any manner.

The invention claimed is:

1. A knitting apparatus for making a multilayer flexible hose, comprising:
an inlet for an inner tubular layer made of a first polymer material;
a first and a second knitting units configured to form, on said inner tubular layer a first and a second textile knitted layer respectively, with stitches of tricot type having wales of stitches and lines of stitches to form a semifinished product defining a longitudinal axis;
an exit for said semifinished product;
a first and a second series of needles associated with each of said first and said second knitting units;
a first and a second series of reels of yarn, operatively coupled to said first and said second series of needles respectively, said first and said second series of reels being susceptible of peripherally rotating about said longitudinal axis to form said first and said second textile layers on an outer surface of said inner tubular layer as said inner tubular layer is moved forward;
cam means operably connecting said needles and said reels so that rotation of said reels causes a reciprocating motion of said needles in a direction substantially parallel to said longitudinal axis; and
first and second motor means susceptible of driving into rotation said first and said second series of reels in opposite directions, so that said lines of stitches of the first and second textile knitted layers have opposite inclinations to said longitudinal axis, the needles of both said first and said second series being rotationally locked so that the wales of stitches of the corresponding textile layer are substantially parallel to said longitudinal axis.

2. The apparatus as claimed in claim 1, wherein the needles of said first and second series face towards each other, to operate in opposed relation.

3. The apparatus as claimed in claim 1, wherein the needles of said first and second series are disposed and operate in a same direction.

4. The apparatus as claimed in claim 1, wherein said first and second motor means are susceptible of driving into rotation said first and second series of reels at substantially equal speeds, so that said lines of stitches also have substantially equal inclinations.

5. A method of making a multilayer flexible hose, comprising the successive steps of:
(a) extruding a first polymer material to obtain a tubular supporting layer;
(b) forming a first textile knitted layer with stitches of tricot type on said tubular supporting layer, to obtain a first semifinished product;
(c) forming a second textile layer with stitches of the tricot type on said first semifinished product, to obtain a second semifinished product; and
(d) extruding a second polymer material on said second semifinished product to obtain an outer layer, thereby forming a finished hose,
wherein said first and second textile layers both include wales of stitches and lines of stitches and are formed with at least some of the lines of stitches having opposite inclinations to a longitudinal axis of the hose, both of said first and second textile layers being formed with the wales of stitches substantially parallel to said longitudinal axis, and
wherein said steps (b) and (c) for forming said textile layers are carried out by a knitting apparatus comprising,
an inlet for the tubular supporting layer, the tubular supporting layer being made from a first polymer material,
a first and a second knitting unit, for forming on the tubular supporting layer the first and the second textile knitted layers respectively, with the stitches of the tricot type having the wales of stitches and the lines of stitches to form the first and the second semifinished products defining the longitudinal axis,
an exit for the second semifinished product,
a first and a second series of needles associated with each of said first and said second knitting units,
a first and a second series of reels of yarn, operatively coupled to the first and the second series of needles respectively, the first and said second series of reels being susceptible of peripherally rotating about the longitudinal axis to form the first and the second textile layers on the outer surface of the tubular supporting layer as the tubular supporting layer is moved forward,
cam means operably connecting the needles and the reels so that rotation of the reels causes a reciprocating motion of the needles in a direction substantially parallel to the longitudinal axis, and
first and second motor means susceptible of driving into rotation the first and the second series of reels in opposite directions, so that the lines of stitches of the first and second textile knitted layers have opposite inclinations to the longitudinal axis, the needles of both the first and the second series being rotationally locked so that the wales of stitches of the corresponding textile layer are substantially parallel to the longitudinal axis.

6. The method as claimed in claim 5, wherein said steps (b) and (c) for forming said textile layers are carried out so that the wales of stitches of said first layer have a predetermined circumferential pitch, a distance between the wales of stitches of said second layer and the wales of stitches of said first layer being substantially half said predetermined circumferential pitch.

7. A flexible hose formed with the method as claimed in claim 5.

8. A line for manufacturing a flexible hose comprising:
an extrusion station configured to extrude a first polymer material to obtain a tubular supporting layer;
at least one knitting station configured to form a first and a second textile knitted layers with stitches of tricot type, in overlapped relation, on said tubular supporting layer; and
an extrusion station configured to extrude a second polymer material on a semifinished product coming out of the at least one knitting station, to obtain an outer layer, thereby forming a finished hose,
wherein said first and second textile layers both include wales of stitches and lines of stitches, said first and second textile layers being formed with at least some of the lines of stitches having opposite inclinations to a longitudinal axis of the hose, both of said first and second textile layers being formed with the wales of stitches substantially parallel to said longitudinal axis, and
wherein said at least one knitting station comprises an apparatus having,
an inlet for the tubular supporting layer, the tubular supporting layer being made from a first polymer material,
a first and a second knitting unit configured to form on the tubular supporting layer the first and the second textile layers respectively, with the stitches of the tricot type having the wales of stitches and the lines of stitches to form a semifinished product defining the longitudinal axis,
an exit for the semifinished product,
a first and a second series of needles associated with each of said first and said second knitting units,
a first and a second series of reels of yarn, operatively coupled to the first and the second series of needles respectively, the first and said second series of reels being susceptible of peripherally rotating about the longitudinal axis to form the first and the second textile layers on the outer surface of the tubular supporting layer as the tubular supporting layer is moved forward,
cam means operably connecting the needles and the reels so that rotation of the reels causes a reciprocating motion of the needles in a direction substantially parallel to the longitudinal axis, and
first and second motor means susceptible of driving into rotation the first and the second series of reels in opposite directions, so that the lines of stitches of the first and second textile knitted layers have opposite inclinations to the longitudinal axis, the needles of both the first and the second series being rotationally locked so that the wales of stitches of the corresponding textile layer are substantially parallel to the longitudinal axis.
